(19) United States
(12) Patent Application Publication
(10) Pub. No.: US 2010/0019108 A1
(43) Pub. Date: Jan. 28, 2010

(54) Holding apparatus and pivot structure thereof

(75) Inventors: Chin-Chen Li, Sinjhuang City (TW); Pei-Shan Wu, Sanchong City (TW)

Correspondence Address: REED SMITH LLP;Suite 1400, 3110 Fairview Park Drive, Falls Church, VA, 22042, US

(73) Assignee: Quanta Computer Inc.

(21) Appl. No.: 12/314,132

(22) Filed: Dec. 4, 2008

(30) Foreign Application Priority Data
Jul. 23, 2008 (TW) 097213132

(51) Int. Cl. F16M 11/20; A47B 96/06

(52) U.S. Cl. 248/124.2; 248/288.51

(57) ABSTRACT

The invention provides a holding apparatus. The holding apparatus comprises a loading stand and a positioning pivot pillar. A pivoting part comprising at least one adjusting unit is set on the loading stand. A pivot member comprising a plurality of locking units is set on one end of the positioning pivot pillar. The pivot member is movably pivoted to the pivoting part. When one of the at least one adjusting unit and one of the plurality of locking units are locked due to a rotation occurred between the loading stand and the positioning pivot pillar, the loading stand and the positioning pivot pillar will form a locked state.

### BACKGROUND OF THE INVENTION

1. Field of the Invention

The invention relates to a holding apparatus, and particularly, to a car-using holding apparatus with a multi-directional pivot and its pivot structure.

2. Description of the Prior Art

With the development of technology in recent years, various kinds of electrical apparatuses have become portable and smaller in size. For example, electrical products, such as notebook, PDA (Personal Digital Assistant), intelligent mobile, and GPS (Global Positioning System) guiding apparatus, have all become smaller and convenient for the user to carry around. Thus, many users use these electrical apparatuses in car.

However, when the driver is driving the car, it is inconvenient for the driver to hold the electrical apparatus in hand, and many car accidents occur because of the distraction of the user. Therefore, in order to ensure that the electrical apparatus is in the sight range of the driver, as well as the protection of the safety of the driver, various kinds of car-using holding apparatus capable of being set in car with a multi-directional pivot. The driver can load the electrical apparatus via this type of car-using holding apparatus and randomly adjusts it to the most comfortable angle for the user to watch.

At present, in most of the common car-using holding apparatuses with the multi-directional pivot on the market, the pivot of the positioning pivot pillar is pivoted to the bottom of the loading stand and used for adjusting the direction of the loading stand. In general, the design theorem of the car-using holding apparatus with the multi-directional pivot is that when the user rotates the car-using holding apparatus, the bottom of the loading stand pivoted to the pivot will press the pivot. In this case, the soft gum part of the pivot surface will be pressed to be deformed to generate a torsion. As to the hard gum part in the pivot, its form will maintain unchanged. That is to say, this design of the car-using holding apparatus actually adjusts the intensity of the torsion generated between the loading stand and the pivot according to the forced condition of the soft gum part of the pivot only.

However, since the material of soft gum part of pivot is generally not an elastomer, after the pivot is continuously and frequently rotated by the user, it is possible that the soft gum part of the pivot generates some level of deformation, so the torsion generated between the loading stand and the pivot becomes smaller. Therefore, after the car-using holding apparatus with the multi-directional pivot is used for a period of time, because the torsion generated between the loading stand and the pivot becomes smaller, it gets harder for the user to rotate the direction of the loading stand. In addition, the car-using holding apparatus with this design can not load heavier electrical apparatuses.

Therefore, the invention provides a holding apparatus and its pivot structure to solve the above-mentioned problems.

### SUMMARY OF THE INVENTION

The invention provides a holding apparatus and its pivot structure. The first embodiment according to the invention is a car-using holding apparatus. The car-using holding apparatus comprises a loading stand and a positioning pivot pillar. In fact, the loading stand is used for containing and bearing an electrical apparatus, such as a PDA, an intelligent mobile, or a GPS guiding apparatus.

In this embodiment, a pivoting part is set on the loading stand, and the pivoting part comprises at least one adjusting unit with a convex structure. A spheral pivot member is set at one end of the positioning pivot pillar. The pivot member comprises a plurality of locking units with a concave structure. The pivot member is movably pivoted to the pivoting part.

In this embodiment, when a rotation is generated between the loading stand and the positioning pivot pillar to lock the adjusting unit of the loading stand to the locking unit of the positioning pivot pillar, a locked state will be formed between the loading stand and the positioning pivot pillar. In fact, the intensity of the loading that the loading stand can bear is related to the locked state formed between the loading stand and the positioning pivot pillar.

In addition, when the rotation is generated between the loading stand and the positioning pivot pillar, if the locked state is not formed between the loading stand and the positioning pivot pillar, that is to say, the adjusting unit of the loading stand is not locked to the locking unit of the positioning pivot pillar, the adjusting unit of the loading stand and the non-locking unit part of the pivot member will contact and compress each other, so that the torsion is generated between the loading stand and the positioning pivot pillar. In practical applications, the intensity of the torsion generated between the loading stand and the positioning pivot pillar is related to the depth of the locking unit with the concave structure on the pivot member.

The second embodiment according to the invention is a pivot structure. In fact, the pivot structure is applied to a car-using holding apparatus. The pivot structure comprises a pivoting part and a pivot member. The pivoting part comprises at least one adjusting unit; the pivot member comprises a plurality of locking units. The pivot member is movably pivoted to the pivoting part.

In this embodiment, when a rotation is generated between the pivoting part and the pivot member to lock the adjusting unit of the pivoting part to the locking unit of the pivot member, the pivoting part and the pivot member will form a locked state.

Moreover, when the rotation is generated between the pivoting part and the pivot member, but the pivoting part and the pivot member do not form a locked state, that is to say, the adjusting unit of the pivoting part is not locked to the locking unit of the pivot member. In this case, the adjusting unit of the pivoting part and the non-locking unit part of the pivot member will contact and compress each other, so that the torsion is generated between the pivoting part and the pivot member. In practical applications, the intensity of the torsion generated between the pivoting part and the pivot member relates to the depth of the locking unit with the concave structure on the pivot member.

Compared to the prior art, because the holding apparatus according to the invention has the design of the locking unit with the concave structure set on the pivot and the adjusting unit with the convex structure set on the bottom of the loading stand, it not only can improve the condition in which the torsion generated between the loading stand and the pivot becomes smaller thus the direction of the loading stand gets harder to be adjusted by the user, but also increases the intensity of the bearing load to enhance the convenience of using the holding apparatus in car.

In addition, the torsion generated between the loading stand and the pivot member can be adjusted by controlling the protruding adjusting unit on the bottom of the loading stand, so that the drooping of the electrical apparatus loaded on the loading stand due to the insufficient friction between the loading stand and the pivot member can also be prevented.

The advantage and spirit of the invention may be understood by the following recitations together with the appended drawings.

### BRIEF DESCRIPTION OF THE APPENDED DRAWINGS

FIG. 1 shows a schematic diagram of the car-using holding apparatus of the first embodiment according to the invention.

FIG. 2 shows a schematic diagram of the structure of the loading stand shown in FIG. 1.

FIG. 3 shows a schematic diagram of the structure of the positioning pivot pillar and the base shown in FIG. 1.

FIG. 4(A) shows a schematic diagram of the locked state formed between the loading stand and the positioning pivot pillar.

FIG. 4(B) shows a schematic diagram of the torsion generated between the loading stand and the pivot member.

FIG. 5(A)-FIG. 5(E) show an example of rotating the loading stand in several sections.

FIG. 6 shows a schematic diagram of the pivot structure of the second embodiment according to the invention.

FIG. 7(A) shows a schematic diagram of the structure of the pivoting part shown in FIG. 6.

FIG. 7(B) shows a schematic diagram of the structure of the pivot member shown in FIG. 6.

FIG. 8(A) shows a schematic diagram of the locked state formed between the pivoting part and the pivot member.

FIG. 8(B) shows a schematic diagram of the torsion generated between the pivoting part and the pivot member.

### DETAILED DESCRIPTION OF THE INVENTION

The invention provides a car-using holding apparatus with a multi-directional pivot and a pivot structure thereof. The car-using holding apparatus can increase its load bearing and torsion intensity by changing the design of the conventional pivot structure of the car-using holding apparatus.

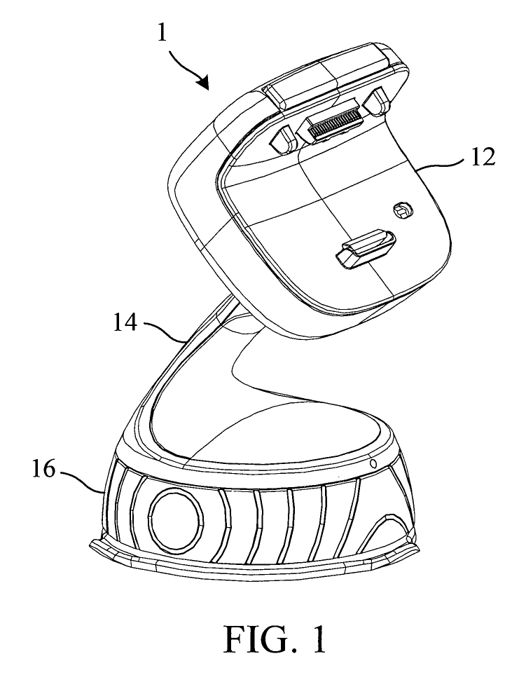

The first embodiment according to the invention is a car-using holding apparatus. Please refer to FIG. 1. FIG. 1 shows a schematic diagram of the car-using holding apparatus. As shown in FIG. 1, the car-using holding apparatus 1 comprises a loading stand 12, a positioning pivot pillar 14, and a base 16.

In fact, the loading stand 12 can be used for containing and bearing an electrical apparatus, such as a notebook, a PDA, an intelligent mobile, or a GPS guiding apparatus. As for the positioning pivot pillar 14, it can be used for supporting the loading stand 12 and connecting to the space or the structure in car via the base 16. The elements of the car-used holding apparatus 1 and their functions will be discussed later.

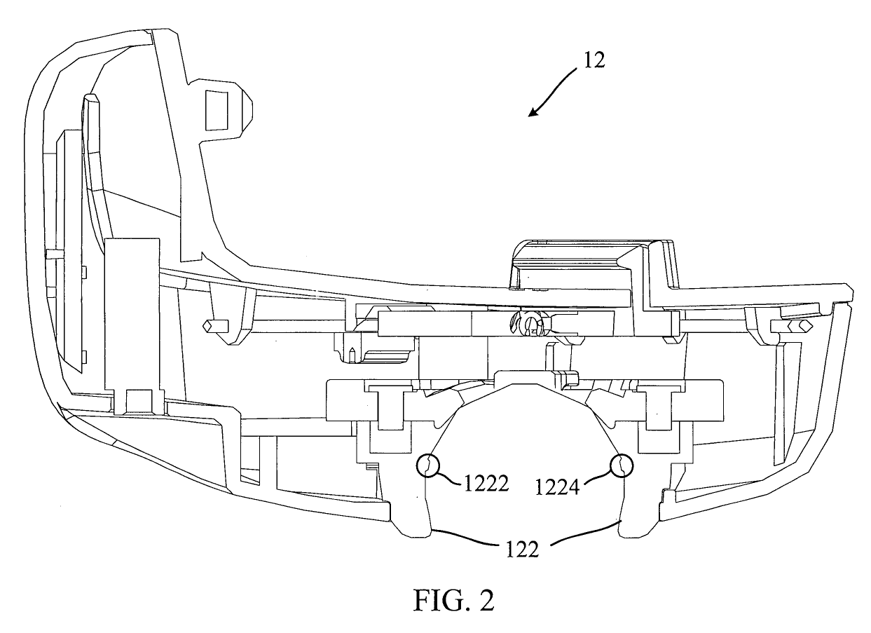

At first, the loading stand 12 of the car-using holding apparatus 1 will be introduced in detail. Please refer to FIG. 2. FIG. 2 shows a schematic diagram of the structure of the loading stand 12. As shown in FIG. 2, a pivoting part 122 is set on the bottom of the loading stand 12, and the pivoting part 122 comprises a first adjusting unit 1222 and a second adjusting unit 1224. In this embodiment, both the first adjusting unit 1222 and the second adjusting unit 1224 have a convex structure. For example, the first adjusting unit 1222 and the second adjusting unit 1224 can be a hemispherical convex, but the form of the convex structure is not limited in this case. In fact, the number of the adjusting unit of the pivoting part 122 does not have to be two in this case. The pivoting part 122 can comprise one or more adjusting units.

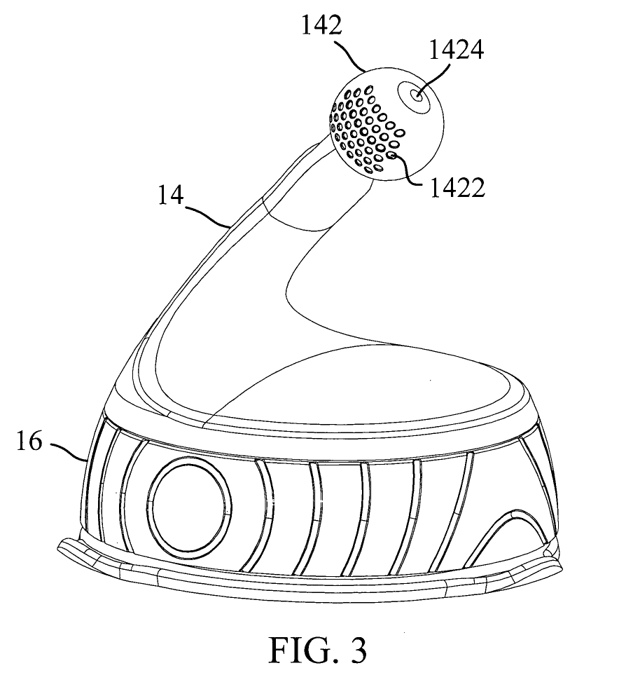

Then, the positioning pivot pillar 14 of the car-using holding apparatus 1 will be introduced. Please refer to FIG. 3. FIG. 3 shows a schematic diagram of the structure of the positioning pivot pillar 14 and the base 16. As shown in FIG. 3, a spheral pivot member 142 is set at one end of the positioning pivot pillar 14; the other end of the positioning pivot pillar 14 connects to the base 16; the base 16 can be set on the structure in a car.

In this embodiment, the surface of the spheral pivot member 142 comprises a plurality of locking units 1422 and a through hole 1424. Each of the locking units 1422 has a concave structure matching the first adjusting unit 1222 and the second adjusting unit 1224 respectively. For example, the locking unit 1422 can be a hemispherical concave on the surface of the spheral pivot member 142, but the form of the concave structure is not limited in this case. It should be explained that the structure of the adjusting unit can be interchanged with the structure of the locking unit. For example, the locking unit can be a hemispherical convex and the adjusting unit can be a hemispherical concave.

As to the through hole 1424, it is an optional design for coupling the lines (e.g., power lines or transmitting lines) to the electrical apparatus set on the loading stand 12 through an inner channel inside the car-using holding apparatus 1 and the through hole 1424. For example, if a mobile is set on the loading stand 12 of the car-using holding apparatus 1, the user can directly charge the mobile via the power line of the car-using holding apparatus 1, or transmits data to the mobile via the transmitting line.

Then, the interaction between the loading stand 12 and the positioning pivot pillar 14 will be discussed. In this embodiment, the pivot member 142 of the positioning pivot pillar 14 is movably pivoted to the pivoting part 122 on the bottom of the loading stand 12. Because the loading stand 12 is supported by the positioning pivot pillar 14 and the loading stand 12 can be rotated in all directions via the pivot member 142, the user can therefore randomly adjust the direction of the loading stand 12 by rotating the loading stand 12.

For example, it is assumed that the car-using holding apparatus 1 is set in front of the driving seat, and a GPS guiding apparatus is put on the loading stand 12 of the car-using holding apparatus 1. If the driver feels that the original angle of the loading stand 12 of the car-using holding apparatus 1 is too low for the driver to clearly see the guiding information shown on the monitor of the GPS guiding apparatus, the driver can rotate the loading stand 12 upward and adjust the direction of the loading stand 12, so that the driver can clearly see the guiding information shown on the monitor of the GPS guiding apparatus.

In addition, it is assumed that the loading stand 12 of the car-used holding apparatus 1 is preset to face the driver. If the passenger beside the driver also wants to see the information shown on the monitor of the GPS guiding apparatus, the passenger can rotate the loading stand 12 rightward and rotate the loading stand 12 toward the passenger. Thus, the passenger can clearly see the information shown on the monitor.

Then, the interaction between the loading stand 12 and the positioning pivot pillar 14 when the user rotates the loading stand 12 will be discussed.

In this embodiment, if the user rotates the loading stand 12 leftward, because the loading stand 12 is pivoted on the pivot member 142 of the positioning pivot pillar 14, so the loading stand 12 will be rotated leftward relative to the positioning pivot pillar 14. In this case, the interaction between the loading stand 12 and the positioning pivot pillar 14 can have two possible conditions.

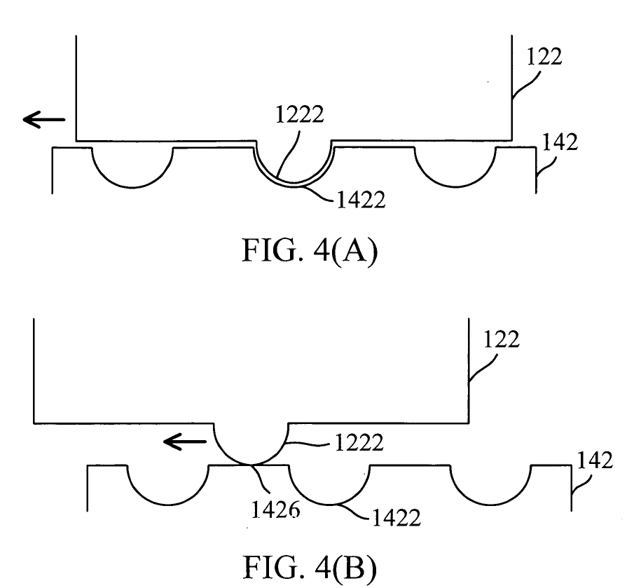

The first possible condition is, as shown in FIG. 4(A), when the first adjusting unit 1222 on the pivoting part 122 of the loading stand 12 is exactly locked to the locking unit 1422 on the pivot member 142 of the positioning pivot pillar 14. In this case, the loading stand 12 and the positioning pivot pillar 14 will form a locked state. In fact, the load intensity the loading stand 12 can bear is related to the locked state. Compared to the conventional car-using holding apparatus, due to the locked state formed by the loading stand 12 and the positioning pivot pillar 14 in the car-using holding apparatus 1, the loading stand 12 can bear the electrical apparatus with more weight.

The second possible condition is, as shown in FIG. 4(B), when the loading stand 12 and the positioning pivot pillar 14 do not form the locked state, that is to say, the first adjusting unit 1222 on the pivoting part 122 of the loading stand 12 is not locked to the locking unit 1422 on the pivot member 142 of the positioning pivot pillar 14. In this case, as shown in FIG. 4(B), the first adjusting unit 1222 will contact with the pivot member 142 at a contacting point 1426. Because the first adjusting unit 1222 has a protruding hemispherical structure, and the contacting point 1426 is at the smooth hemispherical surface of the pivot member 142, therefore, the first adjusting unit 1222 rotated leftward by the user will be pressed and rubbed with the pivot member 142 to generate a torsion.

In fact, in order to form a closely locked state between the loading stand 12 and the positioning pivot pillar 14, the depth of the hemispherical concave of the locking unit 1422 corresponds to the height of the hemispherical convex of the first adjusting unit 1222. In the design of the conventional car-using holding apparatus, the torsion generated between the loading stand and the pivot can be adjusted according to the forced condition of the soft gum part of pivot pressed by the bottom of loading stand. However, the intensity of the torsion generated between the loading stand 12 and the positioning pivot pillar 14 of the car-using holding apparatus 1 according to the invention will be related to the depth of the locking unit 1422 and the height of the first adjusting unit 1222 (or the second adjusting unit 1224).

In general, if the depth of the locking unit 1422 (or the height of the first adjusting unit 1222) is larger, when the user rotates the loading stand 12 to make the locking unit 1422 and the first adjusting unit 1222 out of the locked state, the intensity of the torsion generated between the loading stand 12 and the positioning pivot pillar 14 also becomes larger. At the same time, the design of the car-using holding apparatus 1 according to the invention can prevent that the torsion generated between the loading stand and the pivot becomes smaller due to the deformation generated by the soft gum part of pivot in the conventional car-using holding apparatus. In addition, in order to make it convenient for the user to rotate the loading stand 12, besides the locking unit 1422, the surface of the pivot member 142 can selectively cover an elastic layer (not shown in the figures).

Moreover, the torsion generated between the loading stand 12 and the pivot member 142 is adjusted by controlling the first adjusting unit 1222 (or the second adjusting unit 1224) with a protruding structure on the bottom of the loading stand 12. Therefore, the drooping of the electrical apparatus loaded on the loading stand 12 due to the insufficient friction between the loading stand 12 and the pivot member 142 can also be prevented.

In this embodiment, there is a plurality of locking units 1422 set on the pivot member 142 of the positioning pivot pillar 14. When the user continuously rotates the loading stand 12, it is possible that the first adjusting unit 1222 and one of the locking units 1422 will form the locked state. Thus, the locking units 1422 can be regarded as the sectioning points of rotating the loading stand 12. In this case, the distance between any two locking units 1422 can be the sectioning distance of rotating the loading stand 12.

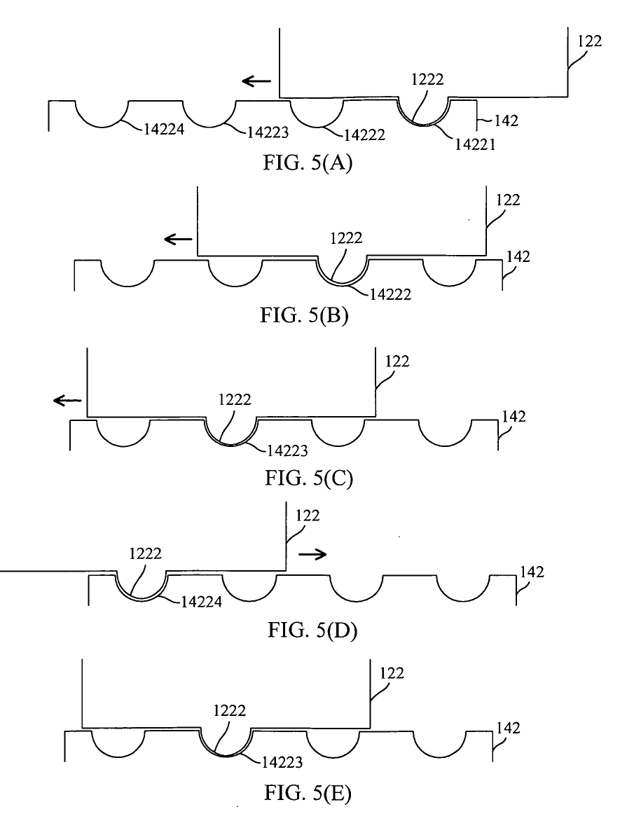

For example, as shown in FIG. 5(A), it is assumed that the first adjusting unit 1222 of the pivoting part 122 is locked in the first locking unit 14221 of the pivot member 142, and the locking units at the left of the first adjusting unit 1222 are in the order of the second locking unit 14222, the third locking unit 14223, and the fourth locking unit 14224. When the user rotates the loading stand 12 leftward, the first adjusting unit 1222 will be moved to the second locking unit 14222 and form the locked state with the second locking unit 14222, as shown in FIG. 5(B). So the second locking unit 14222 can be seen as a first sectioning point. Then, when the user continuously rotates the loading stand 12 leftward, the first adjusting unit 1222 will be moved from the second locking unit 14222 to the third locking unit 14223, as shown in FIG. 5(C). So the third locking unit 14223 can be seen as a second sectioning point.

Similarly, if the user continuously rotates the loading stand 12 leftward, the first adjusting unit 1222 will be moved from the third locking unit 14223 to the fourth locking unit 14224, as shown in FIG. 5(D). So the fourth locking unit 14224 can be seen as a third sectioning point. If the user feels that rotating the first adjusting unit 1222 leftward to the third sectioning point is too much, the user can rotate the loading stand 12 rightward to move the first adjusting unit 1222 back to the second sectioning point, as shown in FIG. 5(E). In addition, it can be known from the above-mentioned description that the more the number of the locking units 1422, the more precisely can the user control the angle or the position of the loading stand 12.

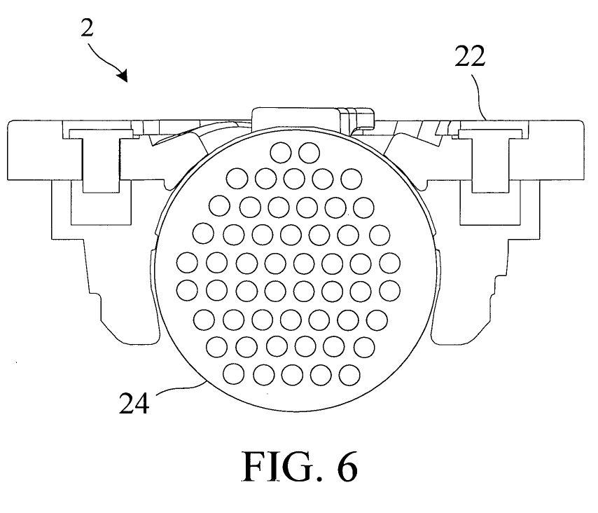

The second embodiment according to the invention is a pivot structure. In fact, the pivot structure is applied to a car-using holding apparatus with a multi-directional pivot. Please refer to FIG. 6. FIG. 6 shows a schematic diagram of the pivot structure. As shown in FIG. 6, the pivot structure 2 comprises a pivoting part 22 and a pivot member 24. Next, the elements of the pivot structure 2 and their functions will be discussed respectively.

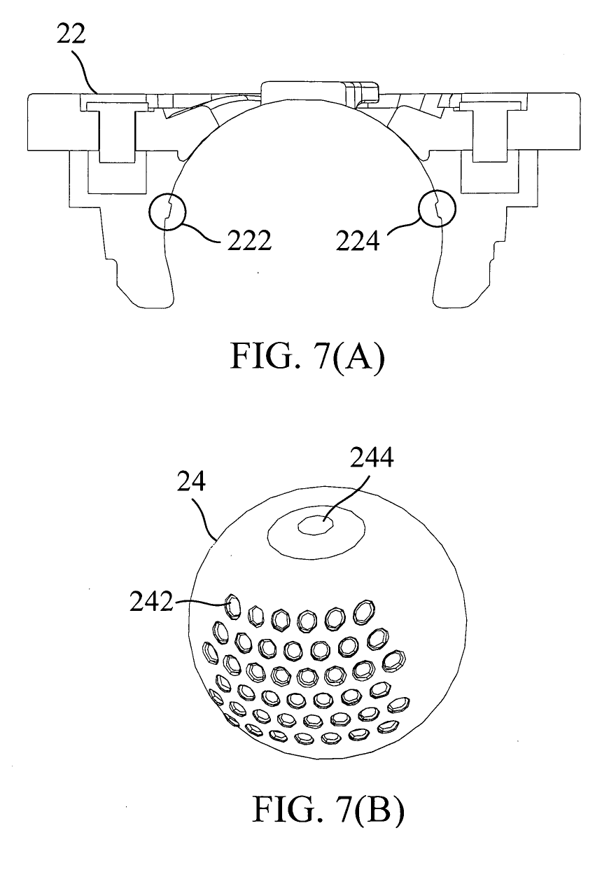

At first, the pivoting part 22 of the pivot structure 2 will be introduced. Please refer to FIG. 7(A). FIG. 7(A) shows a schematic diagram of the structure of the pivoting part 22. As shown in FIG. 7(A), the pivoting part 22 comprises a first adjusting unit 222 and a second adjusting unit 224. In fact, the number of the adjusting unit of the pivoting part 22 is not limited in this case; the pivoting part 22 can comprise one or more adjusting units.

In this embodiment, both the first adjusting unit 222 and the second adjusting unit 224 have a convex structure. For example, the first adjusting unit 222 and the second adjusting unit 224 can be a hemispherical convex, but the form of the convex structure is not limited in this case.

Please refer to FIG. 7(B). FIG. 7(B) shows a schematic diagram of the structure of the pivot member 24. As shown in FIG. 7(B), the surface of the spheral pivot member 24 comprises a plurality of locking units 242 and a through hole 244. Each of the locking units 242 has a concave structure respectively to match the first adjusting unit 222 and the second adjusting unit 224. For example, the locking unit 242 can be a hemispherical concave on the surface of the pivot member 24, but the form of the concave structure is not limited by this case. In fact, the surface of the pivot member 24 can also cover an elastic layer. It should be explained that the structure of the adjusting unit can be interchanged with the structure of the locking unit. For example, the locking unit can be a hemispherical convex and the adjusting unit can be a hemispherical concave.

As to the through hole 244 on the surface of the pivot member 24, it is designed for coupling the lines (e.g., power lines or transmitting lines) to the electrical apparatus set on the loading stand through an inner channel inside the car-using holding apparatus and the through hole 244 when the pivot structure 2 is used in the car-using holding apparatus. Thus, even the electrical apparatus set on the loading stand, the electrical apparatus can be charged or transmit data.

Then, the interaction between the pivoting part 22 and the pivot member 24 will be discussed. In this embodiment, the pivot member 24 is movably pivoted to the pivoting part 22. Therefore, the user can randomly adjust the direction of the pivoting part 22 by rotating the pivoting part 22.

Next, two possible interaction states between the pivoting part 22 and the pivot member 24 when the user rotates the pivoting part 22 will be discussed.

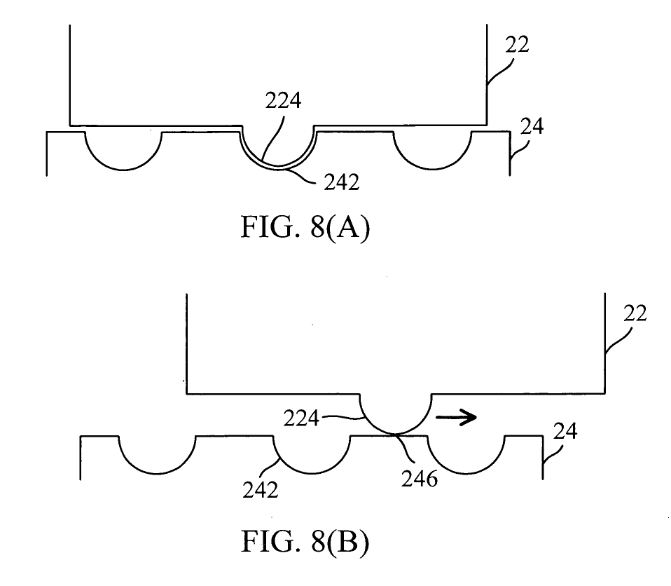

The first possible interaction state is, as shown in FIG. 8(A), if the second adjusting unit 224 of the pivoting part 22 is locked to one of the locking units 242. In this case, the pivoting part 22 and the pivot member 24 will form the locked state. Compared to the conventional car-using holding apparatus, the car-using holding apparatus with the pivot structure 2 according to the invention has the locked state formed between the pivoting part 22 and the pivot member 24, therefore, the loading stand can bear heavier electrical apparatus.

The second possible interaction state is, as shown in FIG. 8(B), if the pivoting part 22 and the pivot member 24 do not form the locked state, that is to say, the second adjusting unit 224 of the pivoting part 22 is not locked to one of the locking units 242. In this case, as shown in FIG. 8(B), the second adjusting unit 224 will contact with the pivot member 24 at the contacting point 246. Because the second adjusting unit 224 has a protruding hemispherical structure, and the contacting point 246 is at the smooth hemispherical surface of the pivot member 24, therefore, the second adjusting unit 224 rotated rightward by the user will be pressed and rubbed with the pivot member 24 to generate a torsion.

In practical applications, when the above-mentioned pivot structure 2 is used in the car-using holding structure, the depth of the hemispherical concave of the locking unit 242 corresponds to the height of the hemispherical convex of the second adjusting unit 224. So that the closed locked state will be formed between the pivoting part 22 and the pivot member 24.

In the design of the conventional car-using holding apparatus, the intensity of the torsion can be adjusted only according to the forced condition of the soft gum part of pivot pressed by the bottom of loading stand. However, the intensity of the torsion generated between the pivoting part 22 and the pivot member 24 of the car-using holding apparatus using the pivot structure 2 according to the invention will be related to the depth of the locking unit 242 and the height of the second adjusting unit 224.

For example, if the depth of the locking unit 242 (or the height of the second adjusting unit 224) is larger, when the user rotates the loading stand, the intensity of the torsion generated between the pivoting part 22 and the pivot member 24 of the pivot structure 2 is also larger. In addition, in order to provide convenience to the user to rotate the loading stand, besides the locking unit 242, the surface of the pivot member 24 can selectively cover an elastic layer (not shown in the figures).

In addition, because there is a plurality of locking units 242 set on the pivot member 24, when the user continuously rotates the pivoting part 22 on the pivot member 24, it is possible that the second adjusting unit 224 and one of the locking units 242 will form the locked state. Therefore, the locking units 242 can be the sectioning points of rotating the pivoting part 22. In this case, the distance between any two locking units 242 can be the sectioning distance of rotating the pivoting part 22. Therefore, the more the number of the locking units 242, the more precise the user can control the angel or position of the pivoting part 22 through rotation.

Compared to the prior art, because the holding apparatus according to the invention has the design of the locking unit with the concave structure set on the pivot member and the adjusting unit with the convex structure set on the bottom of the loading stand, it not only can improve the condition in which the torsion generated between the loading stand and the pivot becomes smaller (after using for a period of time), thus the direction of the loading stand gets harder to be adjusted by the user, but it also increases the intensity of the bearing load that enhances the convenience when using a holding apparatus in car. In addition, the torsion generated between the loading stand and the pivot member can be adjusted by controlling the protruding adjusting unit on the bottom of the loading stand, so that the drooping of the electrical apparatus loaded on the loading stand due to the insufficient friction between the loading stand and the pivot member can also be prevented.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A holding apparatus, comprising:
a loading stand, a pivoting part set on the loading stand, the pivoting part comprising at least one adjusting unit; and
a positioning pivot pillar, a pivot member set on a first end of the positioning pivot pillar, the pivot member being movably pivoted to the pivoting part, the pivot member comprising a plurality of locking units;
wherein if one of the at least one adjusting unit is locked to one of the plurality of locking units due to a rotation generated between the loading stand and the positioning pivot pillar, the loading stand and the positioning pivot pillar will form a locked state.

2. The holding apparatus of claim 1, wherein if the rotation is generated between the loading stand and the positioning pivot pillar, but the loading stand and the positioning pivot pillar do not form the locked state, a torsion will be generated between the loading stand and the positioning pivot pillar.

3. The holding apparatus of claim 2, wherein the intensity of the torsion relates to the depth of the locking unit.

4. The holding apparatus of claim 1, wherein the surface of the pivot member is covered by an elastomer.

5. The holding apparatus of claim 1, wherein the loading stand is used for containing and bearing an electrical apparatus.

6. The holding apparatus of claim 1, wherein the intensity of loading the loading stand can bear relates to the locked state.

7. The holding apparatus of claim 1, wherein the pivot member has a spherical structure.

8. The holding apparatus of claim 1, wherein the adjusting unit has a convex structure.

9. The holding apparatus of claim 1, wherein the locking unit has a concave structure.

10. The holding apparatus of claim 1, wherein a second end of the positioning pivot pillar is coupled to a base.

11. A pivot structure, applied to a holding apparatus, comprising:
a pivoting part comprising at least one adjusting unit; and
a pivot member comprising a plurality of locking units, the pivot member being movably pivoted to the pivoting part;
wherein if one of the at least one adjusting unit is locked to one of the plurality of locking units due to a rotation generated between the pivoting part and the pivot member, the pivoting part and the pivot member will form a locked state.

12. The pivot structure of claim 11, wherein if the rotation is generated between the pivoting part and the pivot member, but the pivoting part and the pivot member do not form the locked state, a torsion will be generated between the pivoting part and the pivot member.

13. The pivot structure of claim 12, wherein the intensity of the torsion relates to the depth of the locking unit.

14. The pivot structure of claim 11, wherein the surface of the pivot member is covered by an elastomer.

15. The pivot structure of claim 11, wherein the pivot member has a spherical structure.

16. The pivot structure of claim 11, wherein the adjusting unit has a convex structure.

17. The pivot structure of claim 11, wherein the locking unit has a concave structure.

18. The pivot structure of claim 11, wherein the holding apparatus is used for containing and bearing an electrical apparatus.

19. The pivot structure of claim 11, wherein the holding apparatus is set in an inner space of a car.
